(19) United States
(12) Patent Application Publication
(10) Pub. No.: US 2017/0127130 A1
(43) Pub. Date: May 4, 2017

(54) DEVICE, SYSTEM, METHOD AND NON-TRANSITORY COMPUTER-READABLE STORAGE MEDIUM FOR IDENTIFYING VIEWER PROFILE

(71) Applicant: INSTITUTE FOR INFORMATION INDUSTRY, TAIPEI (TW)

(72) Inventors: Sheng-Chang CHEN, Taipei City (TW); Rong-Sheng WANG, Taipei City (TW); Shu-Ming HSU, New Taipei City (TW); Hao-Cheng WANG, New Taipei City (TW); Jhuo-Syun LI, Taichung City (TW); Shih-Chun CHOU, Taipei City (TW)

(21) Appl. No.: 14/952,934

(22) Filed: Nov. 26, 2015

(30) Foreign Application Priority Data
Nov. 4, 2015 (TW) 104136353

(51) Int. Cl. H04N 21/45; G06F 17/30; H04N 21/442; H04N 21/278; H04N 21/4223

(52) U.S. Cl. CPC H04N 21/4532; H04N 21/278; H04N 21/4223; H04N 21/44218; G06F 17/30312; G06F 17/30828

(57) ABSTRACT

A device, a system, a method and a non-transitory computer-readable storage medium for identifying viewer profile are disclosed herein, in which the device includes a database, an input unit and a processing unit, and the processing unit is electrically coupled to the database and the input unit. The database is configured to store a plurality of viewer profiles. The input unit is configured to receive a plurality of real-time viewing data. The processing unit is configured to determine a real-time viewer profile according to the viewer profiles and the real-time viewing data.

### RELATED APPLICATIONS

This application claims priority to Taiwan Application Serial Number 104136353, filed Nov. 4, 2015, which is herein incorporated by reference.

### BACKGROUND

Technical Field

The present disclosure relates to an identifying technology. More particularly, the present disclosure relates to a device, a system, a method and a non-transitory computer-readable storage medium for identifying viewer profile.

Description of Related Art

Recently, television (TV) becomes one of entertainment that people usually choose in daily life. When watching TV, habits and preferences of every viewer may be similar or very different. Even though living in the same house, habits of every member in the house when watching TV may not be the same.

With regard to investigation of television household, a television household is usually taken as a profile. However, there are actually lots of viewers in a television household, and they have different preferences and habits when watching TV. In order to identify different viewers or viewing profiles, face recognition technology is well known and utilized. That is, viewers' faces are recorded by a video camera, identified and corresponded with programs that the viewers are watching. However, in a situation that lots of people watch programs in the same time, face recognition technology cannot electively identify a user that uses a remote control from the people. Moreover, position of the video camera utilized in face recognition technology also affect accuracy of recognition and involves personal privacy so that face recognition technology is not suitable for wide application.

### SUMMARY

In order to effectively identify habits of viewers in a household when watch TV programs, and different habits of the same viewer in different conditions when watch TV programs, an aspect of the present disclosure provides a device for identifying viewer profile. The device includes a database, an input unit and a processing unit. The processing unit is electrically coupled to the database and the input unit. The database is configured to store a plurality of viewer profiles. The input unit is configured to receive a plurality of real-time viewing data. The processing unit is configured to determine a real-time viewer profile according to the viewer profiles and the real-time viewing data.

Another aspect of the present application provides a system for identifying viewer profile. The system includes an identifying device and an analyzing device. The analyzing device is connected to identifying device. The identifying device includes a database, an input unit and a processing unit. The processing unit is electrically coupled to the database and the input unit. The database is configured to store a plurality of viewer profiles. The input unit is configured to receive a plurality of real-time viewing data. The processing unit is configured to determine a real-time viewer profile according to the viewer profiles and the real-time viewing data. The analyzing device is configured to generate the viewer profiles according to a plurality of viewing data and send the viewer profiles to the database of the identifying device for storage.

In an embodiment of the present disclosure, the identifying device further comprises an output unit. The output unit is connected to the analyzing device. The output unit outputs the real-time viewing data to the analyzing device. The analyzing device sets the real-time viewing data as the viewing data to generate the viewer profiles.

In an embodiment of the present disclosure, wherein the analyzing device generates a plurality of feature data according to the viewing data, and generates the viewer profiles according to the feature data through a clustering method.

In an embodiment of the present disclosure, wherein the output unit outputs the real-time viewing data to the analyzing device, and the analyzing device sets the real-time viewing data as the viewing data to updates the viewer profiles.

In an embodiment of the present disclosure, wherein the viewing data comprise a plurality of control signals that are generated by a remote control device and a plurality of time data corresponding to the control signals.

In an embodiment of the present disclosure, wherein the identifying device further comprises a connection unit. The connection unit is configured to connect to a video device, and receive a plurality of video channel data of the video device. The viewing data further comprises a real-time video channel datum corresponding to each of the control signal. The processing unit is further configured to determine a recommended video channel datum from the video channel data according to the control signals that are generated by the remote control device.

An aspect of the present application provides a method for identifying viewer profile adaptable to an electronic device. The electronic device stores a plurality of viewer profiles, and the method comprises following steps. A plurality of real-time viewing data are received by the electronic device. A real-time viewer profile is determined according to the viewer profiles and the real-time viewing data by the electronic device.

In an embodiment of the present disclosure, the real-time viewing data are outputted to an analyzing device by the electronic device. The real-time viewing data are set as the viewing data to generate the viewer profiles and send the viewer profiles to the database of the electronic device for storage by the analyzing device.

In an embodiment of the present disclosure, a plurality of feature data are generated according to the viewing data by the analyzing device. The viewer profiles are generated according to the feature data through a clustering method by the analyzing device.

In an embodiment of the present disclosure, the real-time viewing data are set as the viewing data to updates the viewer profiles by the analyzing device.

In an embodiment of the present disclosure, the real-time viewer profile is determined through a classifier by the electronic device.

In an embodiment of the present disclosure, wherein the viewing data comprise a plurality of control signals that are generated by a remote control device and a plurality of time data corresponding to the control signals.

In an embodiment of the present disclosure, a video device is connected and a plurality of video channel data of the video device are received by the electronic device. The viewing data further comprise a real-time video channel datum corresponding to each of the control signal. A recommended video channel datum is determined from the video channel data by the electronic device according to the control signals that are generated by the remote control device.

Another aspect of the present disclosure provides a non-transitory computer-readable storage medium storing a program that is loaded and executed by a computer, performs a method for identifying viewer profile adaptable to an electronic device. The electronic device stores a plurality of viewer profiles, and the method comprises following steps. A plurality of real-time viewing data are received by the electronic device. A real-time viewer profile is determined according to the viewer profiles and the real-time viewing data by the electronic device.

In an embodiment of the present disclosure, the real-time viewing data are outputted to an analyzing device by the electronic device. The real-time viewing data are set as the viewing data to generate the viewer profiles and send the viewer profiles to the database of the electronic device for storage by the analyzing device.

In conclusion, the present disclosure can determine user's real-time viewer profile according to real-time viewing data generated by a remote control device that the user operates when watching TV programs, in order to determine preference of the user.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a system for identifying viewer profile according to an embodiment of the present disclosure;

FIG. 2 is a schematic diagram of a system for identifying viewer profile according to an embodiment of the present disclosure;

FIG. 3 is a flow chart of a method for identifying viewer profile according to an embodiment of the present disclosure; and

FIG. 4 is a flow chart of a method for identifying viewer profile according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

In this document, the term “coupled” may also be termed as “electrically coupled”, and the term “connected” may be termed as “electrically connected”. “coupled” and “connected” may also be used to indicate that two or more elements cooperate or interact with each other.

Unless otherwise indicated, all numbers expressing quantities, conditions, and the like in the instant disclosure and claims are to be understood as modified in all instances by the term “about.” The term “about” refers, for example, to numerical values covering a range of plus or minus 20% of the numerical value. The term “about” preferably refers to numerical values covering range of plus or minus 10% (or most preferably, 5%) of the numerical value. The modifier “about” used in combination with a quantity is inclusive of the stated value.

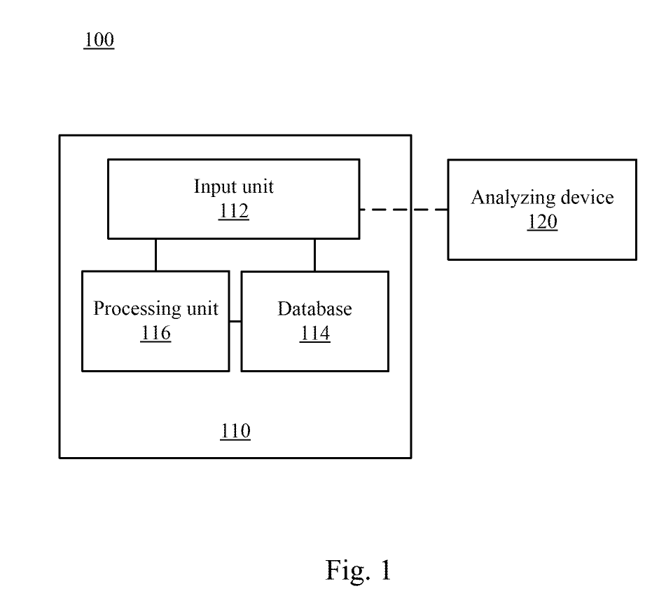

FIG. 1 is a schematic diagram of a system 100 for identifying viewer profile according to an embodiment of the present disclosure. The system 100 includes an identifying device 110 and an analyzing device 120. The identifying device 110 includes an input unit 112, a database 114 and a processing unit 116, and the processing unit 116 is electrically coupled to the database 114 and the input unit 112. The analyzing device 120 is connected to the input unit 112. The database 114 is configured to store a plurality of viewer profiles. The input unit 112 is configured to receive a plurality of real-time viewing data, and the real-time viewing data can be from a remote control device that operated by a user. The processing unit 116 is configured to determine a real-time viewer profile according to the viewer profiles and the real-time viewing data. Specifically, the processing unit 116 uses the real-time viewing data to compare with the viewer profiles in the database 114, and determines a viewer profile with a highest similarity, i.e., the real-time viewer profile. In one embodiment, the processing unit 116 determines the real-time viewer profile through a classifier. For example, the classifier includes but not limit to support vector machine (SVM) classifier, random forest classifier, or naive Bayes classifier.

The aforementioned viewer profiles indicate modes of users when watching TV programs, and it is not limited to a single user or many users. In other words, the same user can have different viewer profiles at different time points, or many users may have the same viewer profile as a viewer profile of single user. The viewer profiles depend on ways that users operate a remote control device in real-time and/or program contents watched by the users, and the viewer profiles can reflect diverse user preferences (e.g., preferences for channels, preferences for TV program types, etc).

As a result, the present disclosure can determine real-time viewer profile of users according to real-time viewing data generated by a remote control device that the users operate every time when watching TV programs in order to determine a present user preference. Compared to the prior art, the present disclosure doesn't need to use an additional video camera and doesn't involve personal privacy, which improves accuracy of recognition and protects personal privacy effectively.

In order to generate the viewer profiles, the analyzing device 120 is configured to generate the viewer profiles according to a plurality of viewing data, and send the viewer profiles to the database 114 of the identifying device 110 for storage. Specifically, the analyzing device 120 generates a plurality of feature data according to the viewing data, and generates the viewer profiles according to the feature data through a clustering method (including but not limit to X-Means clustering, for example).

TABLE 1

| | | | | | Category |
|---|---|---|---|---|---|
| | | | | Category | number of |
| | | | Time | number of | preference |
| | | | period | preference | for TV |
| | Viewing | Switching | of starting | for | program |
| | time | frequency | to view | channel | contents |
| Data 1 | 120 minutes | 0.133/minute | 19 | 1 | 1 |
| Data 2 | 30 minutes | 0.9/minute | 44 | 2 | 2 |
| Data 3 | 150 minutes | 0.2/minute | 28 | 1 | 1 |
| Data 4 | 75 minutes | 0.4/minute | 38 | 3 | 3 |
| Data 5 | 45 minutes | 0.7/minute | 42 | 2 | 2 |

As shown in Table 1, the analyzing device 120 can use the viewing data, such as viewing data of data 1-data 5, to generate corresponding feature data. Data recorded in Table 1 are feature data corresponding to the data 1-data 5. For example, the viewing data can be but not limit to control signals and corresponding time data when a user starts to operate a remote control device, and present channel data, etc. The control signals can include signals generated when the user starts to watch TV programs and presses up and down buttons on the remote control device, enters numbers of channels, turns voice volume up or down, or presses a functional button on the remote control device. Each of the viewing data has corresponding time data, and then the analyzing device 120 can compute a time period that a user starts to watch TV programs, channel searching time before a user starts to watch TV programs, switching frequency before a user starts to watch TV programs, watched channels, and viewing time according to a plenty of viewing data with a sequence. The analyzing device 120 can acquire names, types and other data of TV programs that the user watches by acquiring relevant data of channel program lists, and then compute required feature data accordingly. For example, the feature data can be but not limit to viewing time, switching frequency, a time period of starting to view, preferences for channels, preferences for TV program contents, and browsing trace, etc. For example, for the convenience of statistic and analysis, the analyzing device 120 divides a day into 48 time periods with a unit of half hours and assigns numbers 1-48 to the time periods. The time period of starting to view is a number corresponding to a time period determined according to the time data when the user starts to operate the remote control device. Category numbers of preferences for channels and category numbers of preferences for TV program contents are numbers assigned to channels and types of TV programs that are classified in advanced, and the analyzing device 120 can classify similar channels or types of TV programs in the same category and record them. The browsing trace is an operation mode recorded every time when the user operates the remote control device, such as ranges or sequences of selecting channels, and the analyzing device 120 can also classify or record a particular browsing trace according to similarity.

The analyzing device 120 then generates the viewer profiles 1-3 according to the feature data through a clustering method. The analyzing device 120 sends the viewer profiles to the database 114 of the identifying device 110 for storage. Therefore, the identifying device 110 in the user's house can determine the real-time viewer profile according to the viewer profiles stored in the database 114 and the received real-time viewing data.

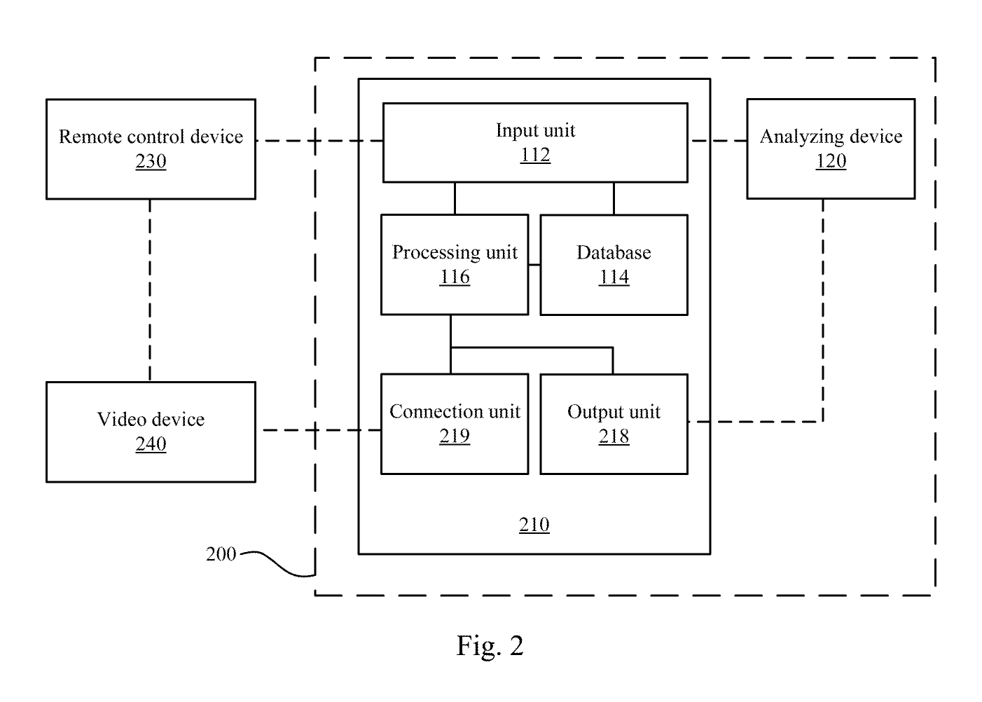

FIG. 2 is a schematic diagram of a system 200 for identifying viewer profile according to an embodiment of the present disclosure. The system 200 has substantially the same configuration as the system 100 in FIG. 1 except for an output unit 218 and a connection unit 219.

In the present embodiment, if there are initially no viewing data, the output unit 218 outputs the real-time viewing data to the analyzing device 120. The analyzing device 120 can receives the real-time viewing data and sets the real-time viewing data as the viewing data to generate a plurality of feature data (e.g., feature data corresponding to data 1-data 5 in Table 1). The analyzing device 120 then categorizes the feature data into a plurality of viewer profiles through a clustering method. After the analyzing device 120 send the viewer profiles to the database 114 of the identifying device 210 for storage, the identifying device 210 computes feature data of every viewer profile through a classifier and records the feature data. In one embodiment, the analyzing device 120 sets the real-time viewing data outputted by the output unit 218 as the viewing data to update the viewer profiles. Even though the viewing data and the viewer profiles exist, the analyzing device 120 can also use continuously received real-time viewing data to update and increase the viewing data, regenerate feature data for clustering, and then update the viewer profiles.

The connection unit 219 is configured to is connected to a video device 240 (e.g., TV), and receive a plurality of video channel data of the video device 240. The viewing data includes control signals and corresponding time data generated by the remote control device 230, and real-time video channel data corresponding to each of the control signals. The processing unit 116 can determine a real-time viewer profile of a user according to the viewing data (including control signals generated by the remote control device 230 that the user operates and real-time video channel data, etc), and then determine a recommended video channel datum from the video channel data.

The recommended video channel datum indicates a recommended video channel determined from the video channel data that the video device 240 can provide, in order to recommend the user. The real-time video channel data can be a video channel currently watched by the user when the user operates the remote control device 230. In one embodiment, the real-time video channel data can be displayed on a main window of the video device 240, and the recommended video channel datum can be displayed on a secondary window (e.g., a pop-up window) of the video device 240. When the user is interest in contents of the recommended video channel datum, the user can operate the remote control device 230 (e.g., press a particular button) to display the recommended video channel datum on the main window of the video device 240.

As a result, when the user operates the remote control device 230 to watch video channels as usual, the processing unit 116 of the identifying device 210 can be configured to determine a recommended video channel datum from the video channel data according to the control signals of the remote control device 230. Because the recommended video channel datum is determined according to the control signals of the remote control device 230, therefore the recommended video channel datum can be close to the user's preference when the user watches TV programs, and then increase the user's motivation to watch the recommended channels.

In the present disclosure, a device for identifying viewer profile can be the identifying device 110 in FIG. 1 or the identifying device 210 in FIG. 2. The identifying devices 110 and 210 can be implanted as set-top boxes (STB). Therefore, those skilled in the art should understand implementation of the input unit 112, the output unit 218 and the connection unit 219, and it would not be repeated herein. The processing unit 116 can be a central processing unit (CPU), a microcontroller or other circuits. For, example, the database 114 can be stored in a storage device, such as a hard disk, any non-transitory computer readable storage medium, or a database accessible from network. Those of ordinary skill in the art can think of the appropriate implementation of the database 114 without departing from the spirit and scope of the present disclosure.

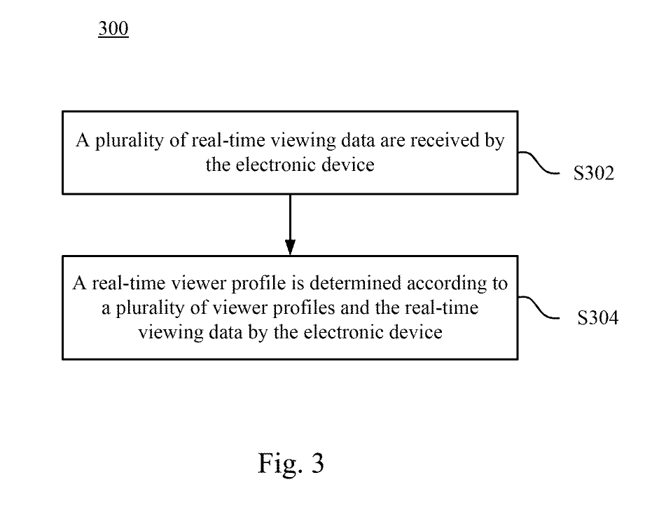

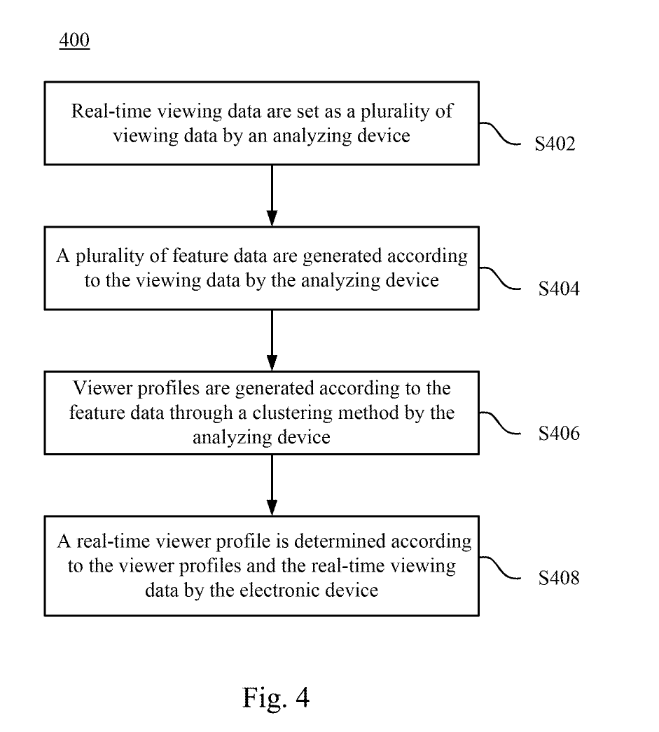

FIGS. 3-4 are flow charts of methods 300, 400 for identifying viewer profile according to some embodiments of the present disclosure. The method 300 includes steps S302-S304, the method 400 includes steps S402-S408, and the methods 300, 400 can be applied to systems 100, 200 as shown in FIGS. 1 and 2. The methods 300, 400 can be implemented as computer programs stored in a computer-readable medium, which is loaded by a computer to make the computer execute the multi-class object classifying method. The non-transitory computer-readable medium can be read only memory (ROM), flash memory, soft disk, hard disk, optical disk, pen drive, magnetic tape, network accessible database, or other computer-readable medium with the same function that are obvious for those skilled in the art. However, those skilled in the art should understand that the mentioned steps in the present embodiment are in an adjustable execution sequence according to the actual demands except for the steps in a specially described sequence, and even the steps or parts of the steps can be executed simultaneously.

In step S302, a plurality of real-time viewing data are received by the electronic device.

In step S304, a real-time viewer profile is determined according to a plurality of viewer profiles and the real-time viewing data by the electronic device.

In order to generate viewer profiles, please refer to FIG. 4.

In step S402, real-time viewing data are set as a plurality of viewing data by an analyzing device.

In step S404, a plurality of feature data are generated according to the viewing data by the analyzing device.

In step S406, viewer profiles are generated according to the feature data through a clustering method by the analyzing device.

In step S408, a real-time viewer profile is determined according to the viewer profiles and the real-time viewing data by the electronic device.

In conclusion, through the embodiments, the present disclosure can determine user's real-time viewer profile according to real-time viewing data generated by a remote control device that the user operates when watching TV programs, in order to determine preference of the user. Moreover, the present disclosure can provide recommended information to the user at appropriate time point according to operation mode (i.e., real-time operation mode) of presently watching TV programs by the user, and provide recommended information that is close to user's preferences to the user at appropriate time point through the real-time viewer profile generated by the system 300. Therefore, the user can be informed of the recommended information without interference, and more willing to watch the recommended information.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A device for identifying viewer profile, comprising:
a database, configured to store a plurality of viewer profiles, wherein the viewer profiles are generated according to a plurality of viewing data by an analyzing device;
an input unit, configured to receive a plurality of real-time viewing data; and
a processing unit, electrically coupled to the database and the input unit, and configured to compare the real-time viewing data with the viewer profiles in the database, and determine a real-time viewer profile from the viewer profiles, wherein the real-time viewer profile has a highest similarity with the real-time viewing data and is corresponding to a user preference for one of a channel and a television program,
wherein the viewing data comprise a plurality of control signals that are generated by a remote control device and a plurality of time data corresponding to the control signals, the analyzing device computes a plurality of feature data according to the viewing data and generates the viewer profiles according to the feature data, and the feature data comprise a viewing time, a switching frequency, a time period of starting to view, the user preference and a browsing trace.

2. A system for identifying viewer profile, comprising:
an identifying device, comprising:
a database, configured to store a plurality of viewer profiles;
an input unit, configured to receive a plurality of real-time viewing data; and
a processing unit, electrically coupled to the database and the input unit, and configured to compare the real-time viewing data with the viewer profiles in the database, and determine a real-time viewer profile from the viewer profiles, wherein the real-time viewer profile has a highest similarity with the real-time viewing data and is corresponding to a user preference for one of a channel and a television program; and
an analyzing device, connected to the input unit and configured to generate the viewer profiles according to a plurality of viewing data and send the viewer profiles to the database of the identifying device for storage,
wherein the viewing data comprise a plurality of control signals that are generated by a remote control device and a plurality of time data corresponding to the control signals, the analyzing device computes a plurality of feature data according to the viewing data and generates the viewer profiles according to the feature data, and the feature data comprise a viewing time, a switching frequency, a time period of starting to view, the user preference and a browsing trace.

3. The system of claim 2, wherein the identifying device further comprises:
an output unit, connected to the analyzing device, wherein the output unit outputs the real-time viewing data to the analyzing device, and
wherein the analyzing device sets the real-time viewing data as the viewing data to generate the viewer profiles.

4. The system of claim 2, wherein the analyzing device generates the viewer profiles according to the feature data through a clustering method.

5. The system of claim 3, wherein the output unit outputs the real-time viewing data to the analyzing device, and the analyzing device sets the real-time viewing data as the viewing data to updates the viewer profiles.

6. The system of claim 2, wherein the processing unit determines the real-time viewer profile through a classifier.

7. (canceled)

8. The system of claim 1, wherein the identifying device further comprises:
a connection unit, configured to connect to a video device, and receive a plurality of video channel data of the video device, wherein the viewing data further comprises a real-time video channel datum corresponding to each of the control signal, the processing unit is further configured to determine a recommended video channel datum from the video channel data according to the control signals that are generated by the remote control device.

9. A method for identifying viewer profile adaptable to an electronic device, wherein the electronic device stores a plurality of viewer profiles, and the method comprises:
by the electronic device, receiving a plurality of real-time viewing data;
by the electronic device, comparing the real-time viewing data with the viewer Profiles in the electronic device;
by the electronic device, determining a real-time viewer profile from the viewer profiles, wherein the real-time viewer profile has a highest similarity with the real-time viewing data and is corresponding to a user preference for one of a channel and a television program; and
by an analyzing device, computing a plurality of feature data according to a plurality of viewing data, generating a plurality of viewer profiles according to the feature data and sending the viewer profiles to the electronic device for storage, wherein the viewing data comprise a plurality of control signals that are generated by a remote control device and a plurality of time data corresponding to the control signals, and the feature data comprise a viewing time, a switching frequency, a time period of starting to view, the user preference and a browsing trace.

10. The method of claim 9, further comprising:
by the electronic device, outputting the real-time viewing data to the analyzing device; and
by the analyzing device, setting the real-time viewing data as the viewing data to generate the viewer profiles.

11. The method of claim 10, further comprising:
by the analyzing device, generating the viewer profiles according to the feature data through a clustering method.

12. The method of claim 9, further comprising:
by the analyzing device, setting the real-time viewing data as the viewing data to updates the viewer profiles.

13. The method of claim 9, further comprising:
by the electronic device, determining the real-time viewer profile through a classifier.

14. (canceled)

15. The method of claim 9, further comprising:
by the electronic device, connecting to a video device, and receiving a plurality of video channel data of the video device, wherein the viewing data further comprises a real-time video channel datum corresponding to each of the control signal; and
by the electronic device, determining a recommended video channel datum from the video channel data according to the control signals that are generated by the remote control device.

16. A non-transitory computer-readable storage medium storing a program that is loaded and executed by a computer, performs a method for identifying viewer profile adaptable to an electronic device, wherein the electronic device stores a plurality of viewer profiles, and the method comprises:
by the electronic device, receiving a plurality of real-time viewing data;
by the electronic device, comparing the real-time viewing data with the viewer profiles in the electronic device;
by the electronic device, determining a real-time viewer profile from the viewer profiles, wherein the real-time viewer profile has a highest similarity with the real-time viewing data and is corresponding to a user preference for one of a channel and a television program; and
by an analyzing device, computing a plurality of feature data according to a plurality of viewing data, generating a plurality of viewer profiles according to the feature data and sending the viewer profiles to the electronic device for storage, wherein the viewing data comprise a plurality of control signals that are generated by a remote control device and a plurality of time data corresponding to the control signals, and the feature data comprise a viewing time, a switching frequency, a time period of starting to view, the user preference and a browsing trace.

17. The non-transitory computer-readable storage medium of claim 16, further comprising:
by the electronic device, outputting the real-time viewing data to the analyzing device; and
by the analyzing device, setting the real-time viewing data as the viewing data to generate the viewer profiles.
